(19) United States
(12) Patent Application Publication
(10) Pub. No.: US 2006/0227107 A1
(43) Pub. Date: Oct. 12, 2006

(54) Laser pointer with a cursor function

(76) Inventor: Ko-Liang Ho, Hsinchuang City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/091,461

(22) Filed: Mar. 29, 2005

(51) Int. Cl. G09G 5/08

(52) U.S. Cl. 345/158

(57) ABSTRACT

A laser pointer with a cursor function has a shell body, a laser pointing module, and a wireless operation module. Both the laser pointing module and the wireless operation module are disposed in the shell body. The laser pointing module controls emission of a laser light. The wireless operation module has a microcontroller and a first operation switch. This microcontroller emits a cursor control signal when the first operation switch is pressed. In addition to providing a laser light with the laser pointing module, the laser pointer with a cursor function can emit the cursor control signal to allow a user to operate the first operation switch for controlling the position change of a computer cursor.

### BACKGROUND OF THE INVENTION

1. Field of the Invention

The present invention relates to a laser pointer and, more particularly, to a laser pointer capable of controlling a computer cursor.

2. Description of Related Art

In addition to good presentation contents, a speaker can use some auxiliary tools during a presentation to facilitate the presentation process. For example, a speaker can use a laser pointer to point a laser light at the presentation contents on a projection screen, thereby guiding an audience through the presentation progress.

TW Pat. No. TW581298 discloses a laser pointer with other additional functions. As shown in FIG. 1, a laser pointer 7 comprises a first button 71, a second button 72, and a third button 73. A page-up control signal is generated when the first button 71 is pressed. A page-down control signal is generated when the second button 72 is pressed. A laser light is emitted when the third button 73 is pressed.

In addition to the original laser pointing function, the laser pointer in TW Pat. No. TW581298 can also page-up and page-down through the presentation contents. Therefore, the speaker no longer needs to use a computer keyboard or a computer mouse to perform the same controls, hence enhancing the fluency of the presentation process.

The laser pointer in TW Pat. No. TW581298, however, still has some problems during operation. For instance, the speaker still needs a computer mouse to control the cursor position on the presentation content, hence somewhat affecting the fluency of the presentation process.

### SUMMARY OF THE INVENTION

One object of the present invention is to provide a laser pointer with a cursor function, which can emit a wireless signal for controlling the motion of a computer cursor to control the position of the computer cursor.

To achieve the above object, the present invention provides a laser pointer with a cursor function, which comprises a shell body, a laser pointing module, and a wireless operation module. Both the laser pointing module and the wireless operation module are disposed in the shell body. The laser pointing module has a push-on switch, and is used to emit a laser light. The wireless operation module has a first operation switch and a microcontroller. The microcontroller is used to detect push-on actions of the first operation switch and wirelessly emit a cursor control signal. The microcontroller wirelessly emits the cursor control signal when the first operation switch is pressed.

To achieve the above object, the present invention also provides a laser pointer with a cursor function, which comprises a shell body, a laser pointing module, and a wireless operation module. Both the laser pointing module and the wireless operation module are disposed in the shell body. The laser pointing module has a push-on switch, and is used to emit a laser light. The wireless operation module has a first operation switch, a second operation switch, a third operation switch, and a microcontroller. The microcontroller is used to detect push-on actions of the first, second, and third operation switches, and wirelessly emit signals. The microcontroller wirelessly emits a cursor control signal when the first operation switch is pressed, wirelessly emits a page-up control-signal when the second operation switch is pressed, and wirelessly emits a page-down control signal when the third operation switch is pressed.

The wireless operation module in the laser pointer with a cursor function of the present invention provides wireless signals capable of controlling the motion of a computer cursor for a wireless receiver at a computer end. In addition to controlling the motion of a computer cursor, page-up and page-down controls are also integrated into the wireless operation module of the laser pointer. Therefore, the laser pointer with a cursor function of the present invention can provide more operations functions, more conveniently, during the presentation process.

### BRIEF DESCRIPTION OF THE DRAWINGS

The various objects and advantages of the present invention will be more readily understood from the following detailed description when read in conjunction with the appended drawing, in which:

FIG. 1 is a perspective diagram of a conventional laser pointer;

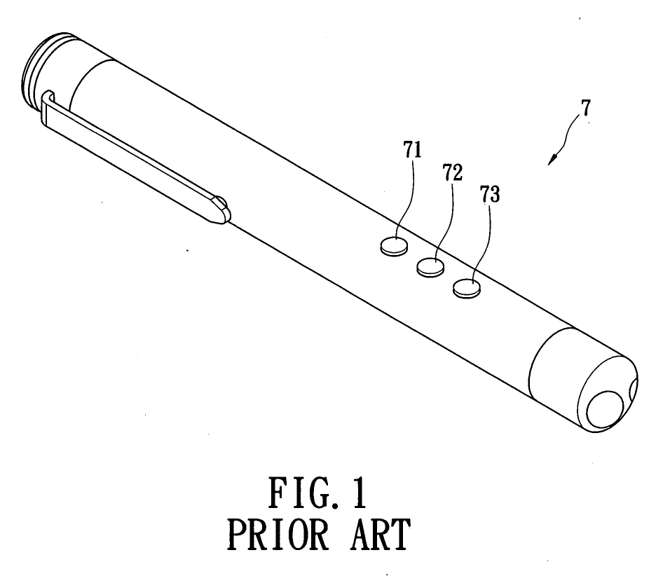

FIG. 2 is a perspective diagram of the present invention;

FIG. 3 is an exploded perspective view of the present invention;

FIG. 4 is a circuit diagram of the present invention; and

FIG. 5 is an operation diagram of the present invention.

### DETAILED DESCRIPTION OF THE PREFERRED EMBODIMENTS

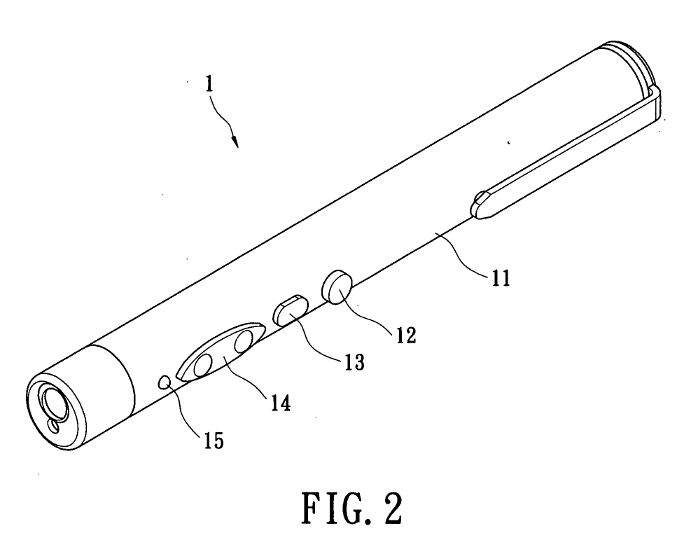

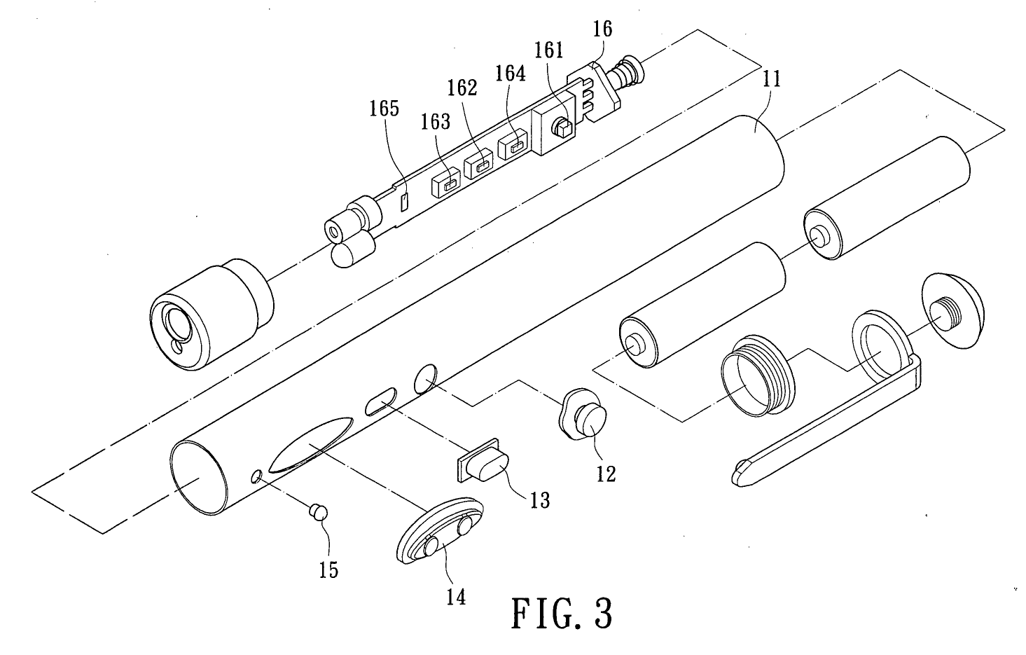

As shown in FIGS. 2 and 3, the present invention provides a laser pointer 1 with a cursor function. The laser pointer 1 has a shell body 11. A circuit board 16 is disposed in the shell body 11. The circuit board 16 has operation functions of a laser pointing module and a wireless operation module. The circuit board 16 has a push-on switch 164, a first operation switch 161, a second operation switch 162, a third operation switch 163, and an indication light 165. A laser light button 13 is sleeved onto the push-on switch 164. A cursor button 12 is sleeved onto the first operation switch 161. A page button 14 is sleeved onto both the second and third operation switches 162 and 163, or two buttons are separately sleeved onto the second operation switch 162 and the third operation switch 163. A light guiding component 15 corresponding to the indication light 165 is disposed on the shell body 11.

According to this embodiment of the present invention, the push-on switch 164 controls emission of a laser light, the first operation switch 161 controls the motion of a computer cursor, the second and third operation switches 162 and 163 respectively control a computer to make a page-up and page-down action, and the indication light 165 is used to indicate whether there is laser light emission, i.e., the indication light is on when the laser light is emitted. When a user presses the laser light button 13, the laser light is emitted. When he presses the cursor button 12, the motion of the computer cursor can be controlled. When he presses the page button 14, the computer can be controlled to make a page-up or page-down action based on the pressed position of the page button 14.

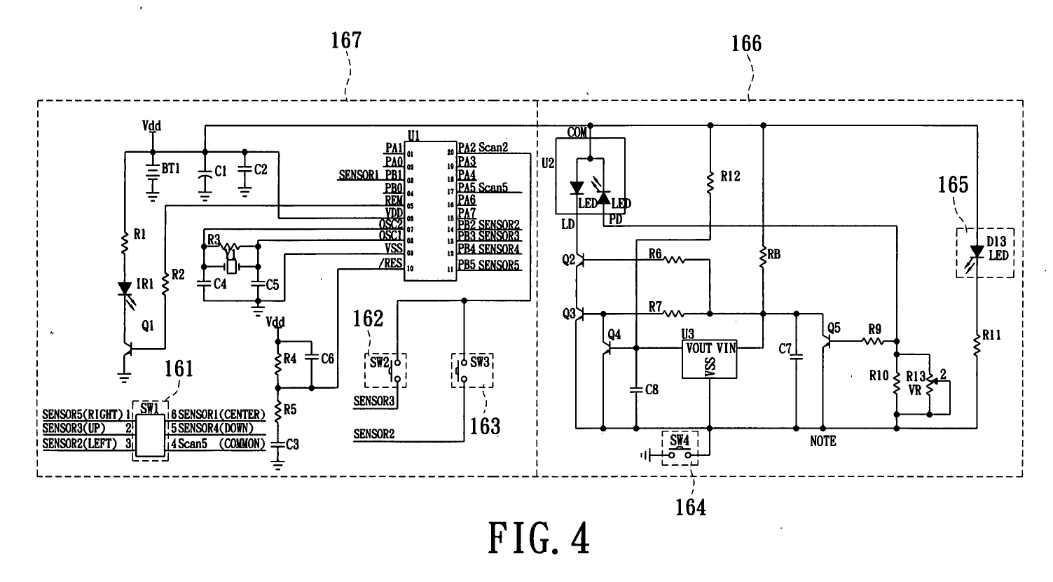

As shown in FIG. 4, the circuit board 16 is composed of a laser pointing module 166 and a wireless operation module 167. A laser head U2 of the laser pointing module 166 emits a laser light when the on-button 164 is pressed. The indication light 165 is used to indicate whether the laser head emits the laser light. The wireless operation module 167 has a microcontroller U1, which can detect push-on actions of the first, second, and third operation switches 161, 162 and 163, and wirelessly emit signals. According to this embodiment of the present invention, the microcontroller U1 wirelessly emits a cursor control signal when the first operation switch 161 is pressed, wirelessly emits a page-up control signal when the second operation switch 162 is pressed, and wirelessly emits a page-down control signal when the third operation switch 163 is pressed.

According to this embodiment of the present invention, the first operation switch 161 is a joystick switch capable of controlling the moving direction of a cursor, and the microcontroller U1 moves the cursor in the pressed direction of the joystick switch. Moreover, the wireless signals emitted by the microcontroller U1 can be received by a wireless receiver at a computer end, so that the computer can receive the cursor control signal, the page-up control signal, and the page-down control signal.

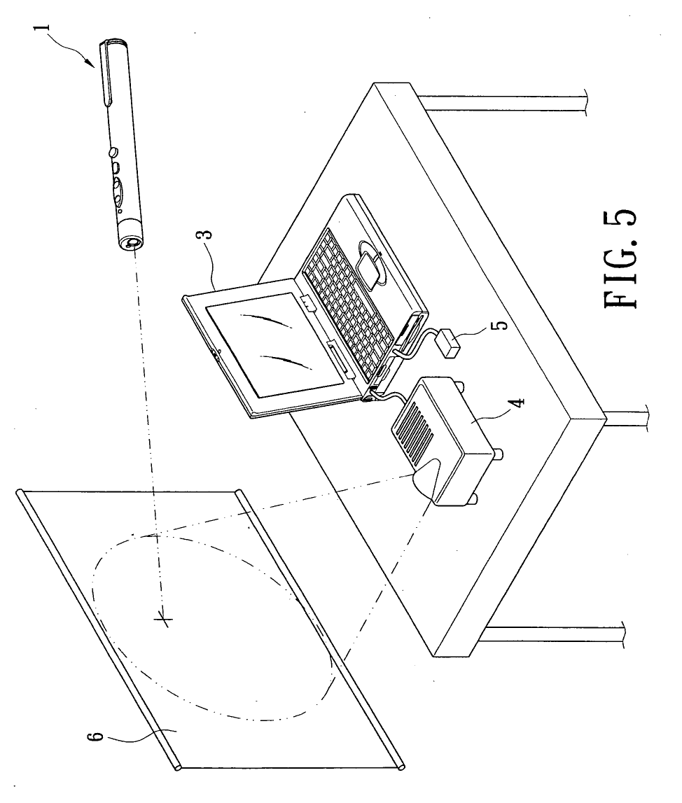

As shown in FIG. 5, a computer 3 is connected with a projector 4 and a wireless receiver 5. The wireless receiver 5 can receive wireless signals emitted by the laser pointer 1 of the present invention. When the presentation content stored in the computer 3 is projected onto a screen 6 by the projector 4, the speaker can use the laser pointer 1 to emit the laser light for pointing at a specific position in the presentation content, or he can control the cursor position in the presentation content, or he can page-up or page-down through the presentation content. Because all these operations are integrated into the laser pointer 1 of the present invention, the degree of fluency of the presentation process is greatly enhanced.

Although the present invention has been described with reference to the preferred embodiment thereof, it will be understood that the invention is not limited to the details thereof. Various substitutions and modifications have been suggested in the foregoing description, and other will occur to those of ordinary skill in the art. Therefore, all such substitutions and modifications are intended to be embraced within the scope of the invention as defined in the appended claims.

I claim:

1. A laser pointer with a cursor function, comprising:
a shell body;
a laser pointing module disposed in said shell body and having a push-on switch, said laser pointing module being used to emit a laser light; and
a wireless operation module disposed in said shell body, said wireless operation module comprising:
a first operation switch; and
a microcontroller used to detect push-on actions of said first operation switch and wirelessly emit a cursor control signal;
whereby said microcontroller wirelessly emits said cursor control signal when said first operation switch is pressed.

2. The laser pointer with a cursor function as claimed in claim 1, wherein said laser pointing module further comprises an indication light for indicating actions of said laser pointing module, wherein said indication light is on when said laser pointing module emits said laser light.

3. The laser pointer with a cursor function as claimed in claim 2, further comprising a light guiding component, wherein said light guiding component is disposed in said shell body and corresponds to said indication light.

4. The laser pointer with a cursor function as claimed in claim 1, wherein a laser light button is sleeved onto said push-on switch.

5. The laser pointer with a cursor function as claimed in claim 1, wherein said laser pointing module and said wireless operation module are disposed on a circuit board.

6. The laser pointer with a cursor function as claimed in claim 1, wherein a cursor button is sleeved onto said first operation switch.

7. The laser pointer with a cursor function as claimed in claim 1, wherein said first operation switch is a joystick switch.

8. A laser pointer with a cursor function, comprising:
a shell body;
a laser pointing module disposed in said shell body and having a push-on switch, said laser pointing module being used to emit a laser light; and
a wireless operation module disposed in said shell body, said wireless operation module comprising:
a first operation switch;
a second operation switch;
a third operation switch; and
a microcontroller used to detect push-on actions of said first, second and third operation switches and wirelessly emit signals;
whereby said microcontroller wirelessly emits a cursor control signal when said first operation switch is pressed, wirelessly emits a page-up control signal when said second operation switch is pressed, and wirelessly emits a page-down control signal when said third operation switch is pressed.

9. The laser pointer with a cursor function as claimed in claim 8, wherein said laser pointing module further comprises an indication light for indicating actions of said laser pointing module, wherein said indication light is on when said laser pointing module emits said laser light.

10. The laser pointer with a cursor function as claimed in claim 9, further comprising a light guiding component, wherein said light guiding component is disposed in said shell body and corresponds to said indication light.

11. The laser pointer with a cursor function as claimed in claim 8, wherein a laser light button is sleeved onto said push-on switch.

12. The laser pointer with a cursor function as claimed in claim 8, wherein said laser pointing module and said wireless operation module are disposed on a circuit board.

13. The laser pointer with a cursor function as claimed in claim 8, wherein a cursor button is sleeved onto said first operation switch.

14. The laser pointer with a cursor function as claimed in claim 8, wherein said first operation switch is a joystick switch.
